(19) United States
(12) Patent Application Publication
(10) Pub. No.: US 2009/0169882 A1
(43) Pub. Date: Jul. 2, 2009

(54) COMPATIBILIZED POLYESTER-POLYAMIDE WITH HIGH MODULUS, AND GOOD ABRASION AND FIBRILLATION RESISTANCE AND FABRIC PRODUCED THEREOF

(76) Inventors: Louis Jay Jandris, Lafayette, NY (US); Kevin S. Cook, Tully, NY (US)

Correspondence Address: FROMMER LAWRENCE & HAUG, 745 FIFTH AVENUE- 10TH FL., NEW YORK, NY, 10151, US

(21) Appl. No.: 11/966,022

(22) Filed: Dec. 28, 2007

(51) Int. Cl. D02G 3/02; C08K 5/29; C08K 7/02; C08L 67/00

(52) U.S. Cl. 428/373; 523/222; 524/195; 523/508

(57) ABSTRACT

The invention is yarn, fiber, film or tape composed of a compatibilized blend of polyester and polyamide resins, with improved fibrillation and abrasion resistance, and an industrial fabric produced thereof. The blend uses carbodiimide (CDI) compound containing at least two carbodiimide groups in the molecule as a compatibilizing agent. A unique, high modulus, dimensionally stable and abrasion resistant yarn, fiber, film or tape is created as a result of the combination of the polyester and polyamide with CDI in a preferred proportion.

### BACKGROUND OF THE INVENTION

1. Field of the Invention

The invention relates to polymeric yarns used in the manufacture of industrial fabrics such as paper machine clothing and engineered fabrics. More particularly, the invention relates to yarns made from a compatibilized blend of polyester and polyamide used in the manufacture of industrial fabrics and a method of manufacturing the same.

2. Description of the Prior Art

Industrial fabrics mean an endless structure in the form of a continuous loop such as one used as a forming fabric, press fabric, dryer fabric or process belt (“paper machine clothing”). It can also be a structure used as an impression fabric, TAD fabric, corrugator belt, an engineered fabric used in the production of nonwovens by processes such as melt-blowing, a fabric used in a sludge filter or other wet filtration processes, or a fabric used in textile finishing processes. While the discussion here is for the papermaking process in general, the application of the present invention is not considered limited thereto.

In general, during the papermaking process, for example, a cellulosic fibrous web is formed by depositing a fibrous slurry, that is, an aqueous dispersion of cellulose fibers, onto a moving forming fabric in a forming section of a paper machine. A large amount of water is drained from the slurry through the forming fabric, leaving the cellulosic fibrous web on the surface of the forming fabric.

The newly formed cellulosic fibrous web proceeds from the forming section to a press section, which includes a series of press nips. The cellulosic fibrous web passes through the press nips supported by a press fabric, or, as is often the case, between two such press fabrics. In the press nips, the cellulosic fibrous web is subjected to compressive forces which squeeze water therefrom, and which adhere the cellulosic fibers in the web to one another to turn the cellulosic fibrous web into a paper sheet. The water is accepted by the press fabric or fabrics and, ideally, does not return to the paper sheet.

The paper sheet finally proceeds to a dryer section, which includes at least one series of rotatable dryer drums or cylinders, which are internally heated by steam. The newly formed paper sheet is directed in a serpentine path sequentially around each in the series of drums by a dryer fabric, which holds the paper sheet closely against the surfaces of the drums. The heated drums reduce the water content of the paper sheet to a desirable level through evaporation.

It should be appreciated that the forming, press and dryer fabrics all take the form of endless loops on the paper machine and function in the manner of conveyors. It should further be appreciated that paper manufacture is a continuous process which proceeds at considerable speeds. That is to say, the fibrous slurry is continuously deposited onto the forming fabric in the forming section, while a newly manufactured paper sheet is continuously wound onto rolls after it exits from the dryer section.

Base fabrics, which form an important portion of the above discussed fabrics, take many different forms. For example, they may be woven either endless or flat woven and subsequently rendered into endless form with a woven seam using one or more layers of machine direction (“MD”) and cross-machine direction (“CD”) yarns. Further, the woven base fabrics may be laminated by placing one base fabric within the endless loop formed by another, and joining or laminating together by various means known to those skilled in the art such as by needling a staple fiber batt through both base fabrics to join them to one another.

Different polymeric materials may be used in the formation of MD/CD yarns and if present, the batt fibers that form these fabrics. Examples of some polymeric resins that may be used for this purpose are polyester and polyamide (PA). However, because these fabrics undergo a high amount of stress and strain on the papermaking machine, it is essential that the material used to form these yarns exhibit good mechanical properties such as high modulus, abrasion resistance, fibrillation resistance, and resistance to chemical degradation. While pure (100%) material used for a yarn, for example, polyester as a forming fabric yarn, has excellent required yarn modulus, it has relatively poor abrasion resistance. While attempts to improve this shortcoming have been made, none have shown the required improvement. As an alternative, this can be achieved by combining two or more materials with desired favorable properties in a compatibilized manner, such that the properties of the individual component materials are maintained and such that the combination itself offers the desired combination of properties in the yarn. However, compatibilization is a difficult task to achieve with two dissimilar polymers.

Blends of normally incompatible polymers can often be created by introducing a reactive component that chemically bonds the two polymer types. The limitation is in finding an appropriate chemical compatibilizer. However, there are not many examples or known commercial methods for blending, for example polyester and polyamide. One example is, however, disclosed in “Process Optimization For Reactive Blending and Compatibilization of PA6 and PET in Extrusion”, S. Prollius, E. Haberstroh, Antech 2001 presentation, which process poses some serious limitations.

Upon mixing two normally incompatible polymers such as polyamide (PA) and polyethylene terephthalate (PET), the phase character of the combination is generally represented as the morphological structure shown in FIG. 1(a). The formation of the matrix and disperse phase of the components depends on different factors, such as for example, the mass or viscosity ratio of the components. In this example, PA always forms the disperse phase. After leaving the mixing zones of an extruder producing the yarns or fiber, the polymer melt experiences shear stress caused by simple conveying elements. As a result of the chemical incompatibilities in an uncompatibilised blend, an enlargement occurs to the disperse phase caused by PA particle coalescence and a conditioned reunification as shown in FIG. 1(b). Finally the chemical and mechanical properties of the blend deteriorate enormously with respect to the properties of each single component because the combination remains in its uncompatibilized phase. This is an observed drawback in the existing systems.

In related art, U.S. Pat. No. 6,319,575, whose teachings are incorporated herein by reference, relates to a polyester resin composition produced by melt-kneading a mixture comprising a polyamide resin and a polyester resin, and a tricarboxylic acid compound. The composition uses anhydrides to improve transparency, whitening resistance and moisture absorbing of films, sheets and thin-wall hollow containers without deteriorating their gas barrier properties. However, since anhydrides pose a serious health risk during manufacture, the above combination cannot be effectively used in an open industrial environment.

Polyester resins produced from a dicarboxylic acid component and a diol component composed mainly of an aliphatic diol (“polyester resin”), typically exemplified by PET, have been extensively used as packaging or wrapping materials such as films, sheets and hollow containers, as well as monofilaments due to their excellent mechanical properties, melt stability, solvent resistance and recyclability.

Polyamide resins such as nylon 6 and nylon 66, especially those produced by polymerization of m-xylylenediamine and adipic acid, i.e. polyamide MXD6, are also known.

Polyamide MXD6 has excellent heat stability at melting, and the glass transition temperature, melting point and crystallinity thereof are close to those of the polyester resins, especially polyethylene terephthalate (PET). Therefore, polyamide MXD6 is advantageous because it is easily compatible with polyester resins by melt mixing; it does not cause deterioration of the mechanical properties and stretchability of the polyester resins; and it exhibits excellent mechanical properties.

Japanese Patent Application No. 1-272660 discloses a composition comprising a mixture of polyamide resin and polyester resin blended with tetracarboxylic dianhydride. The resin composition disclosed therein is different from the polyester and polyamide resin composition of the present invention in its chemical composition. Although the composition in the '660 application is taught to improve mechanical properties of molded products usable as engineering plastics, the prior art is quite silent as to a resin composition suitable for the production of fibers, filaments, or yarns for use in an industrial fabric.

Japanese Patent Publication No. 6-2871 proposes the use of a compound having an epoxy group and acid anhydride group to compatibilize a thermoplastic polyester resin with a polyamide resin containing a m-xylylene group in the main polymer chain. Anhydride applications as discussed above, however, pose a serious health risk during handling, and therefore cannot be effectively used in an open industrial environment.

The present invention attempts to improve the mechanical and/or chemical properties, for example, of yarns or fibers by blending polyester with polyamide resin using a suitable compatibilizer. It is commonly known in the art that a polyamide monofilament, in general, has excellent abrasion resistance along with high modulus (up to ˜90 gpd). Because of the need for a “tougher” high modulus yarn material in industrial applications, one aspect of the present invention was aimed at producing monofilaments made from compatibilized polyester-polyamide blended resin for use in yarns for industrial fabrics.

The present invention specifically relates to a multicomponent (including bicomponent and sheath-core) yarn or fiber having excellent mechanical properties such as high modulus, abrasion resistance and fibrillation resistance, and resistance to chemical degradation, which comprises, as main components, a polyamide resin produced from one or more amine components and a polyester resin produced from one or more carboxylic acid components, which are combined to produce a compatibilized mixture using a suitable compatibilizer. The present invention further relates to fibers, filament yarns, films and tapes produced by extruding this polyester-polyamide resin composition.

### SUMMARY OF THE INVENTION

It is an object of the present invention to provide a compatibilized polyester-polyamide resin composition comprising a polyester resin and a polyamide resin which is suitable for the production of fibers, filaments, film and tapes exhibiting improved mechanical properties such as high modulus, good abrasion resistance, and fibrillation resistance compared to yarns of pure 100% resin or other prior art combinations.

It is another object of the present invention to provide an industrial fabric with improved mechanical properties such as high modulus, good abrasion resistance, and fibrillation resistance produced using a compatibilized polyester, such as for example polyethylene terephthalate (PET), polyethylene naphthalate (PEN), polybutylene terephthalate (PBT), polybutylene naphthalate (PBN), polytrimethylene naphthalate (PTN), aromatic, copolymers or blends of polyester, and polyamide, such as, for example PA 6; PA 6,6; PA 6,12; PA 6,10; PA 4,6; PA10; PA12; or MXD6; aromatic, copolymers or blends of polyamides.

Yet another object of the present invention is to provide a monofilament for use in an industrial fabric with excellent mechanical properties due to a bicomponent structure, such as for example sheath-core compatibility, which reduces or even eliminates delamination due to the improved compatibility. The structure may be of a sheath-core form, wherein either the sheath includes a polyester-polyamide resin composition and the core is 100% pure, such as for example, PET, PEN, PBT, PBN, PTN, PA 6, PA 6,6, PA 6,12, PA 6,10, PA 4,6, PA10, PA12 or MXD6, or vice versa.

The polyester-polyamide resin composition according to the present invention is suitable for the production of fibers and filament yarns. More specifically, the polyester-polyamide resin composition is suitable for manufacturing yarns, fibers, films and tapes made from a compatibilized blend of polyester and polyamide that can be used in the manufacture of forming, press, dryer fabrics and other industrial fabrics, and a method of manufacturing the same.

A resin composition suitable for the production of fiber, filaments, yarns, tapes and films exhibiting the above discussed properties is obtained by blending a suitable compatabilizer compound with a mixture of a polyester resin and a polyamide resin. Thus, the present invention provides the following examples of polyester-polyamide resin compositions:

(I) A polyester-polyamide resin composition produced by melt-extruding 100 parts by weight of a mixture comprising 50 to 98.99% by weight of a polyester resin produced by polymerization of a carboxylic acid component, such as PEN, and 1 to 49.99% by weight of a polyamide resin produced by polymerization of an amine component, such as MXD6, and 0.01 to 3% by weight of a compatibilizer, such as carbodiimide, containing at least two carbodiimide groups in the molecule. Preferably, a mixture comprising 75 to 98.99% by weight of a polyester resin produced by polymerization of a carboxylic acid component, such as PEN, and 24.99 to 1% by weight of a polyamide resin produced by polymerization of an amine component, such as MXD6, and 0.01 to 3% by weight of a compatibilizer, such as carbodiimide, containing at least two carbodiimide groups in the molecule.

(II) A polyester-polyamide resin composition produced by melt-extruding 100 parts by weight of a mixture comprising 50 to 98.99% by weight of a polyester resin produced by polymerization of a carboxylic acid component, such as PET, and 1 to 49.99% by weight of a polyamide resin produced by polymerization of an amine component, such as MXD6, and 0.01 to 3% by weight of a compatibilizer, such as carbodiimide, containing at least two carbodiimide groups in the molecule. Preferably, a mixture comprising 75 to 98.99% by weight of a polyester resin produced by polymerization of a carboxylic acid component, such as PET and 24.99 to 1% by weight of a polyamide resin produced by polymerization of an amine component, such as MXD6 and 0.01 to 3% by weight of a compatibilizer, such as carbodiimide, containing at least two carbodiimide groups in the molecule.

(III) A polyester-polyamide resin composition produced by melt-extruding 100 parts by weight of a mixture comprising 50 to 98.99% by weight of a polyester resin produced by polymerization of a carboxylic acid component, such as PBT, and 1 to 49.99% by weight of a polyamide resin produced by polymerization of an amine component, such as MXD6, and 0.01 to 3% by weight of a compatibilizer, such as carbodiimide, containing at least two carbodiimide groups in the molecule. Preferably, a mixture comprising 75 to 98.99% by weight of a polyester resin produced by polymerization of a carboxylic acid component, such as PBT and 24.99 to 1% by weight of a polyamide resin produced by polymerization of an amine component, such as MXD6, and 0.01 to 3% by weight of a compatibilizer, such as carbodiimide, containing at least two carbodiimide groups in the molecule.

More particularly, the present invention relates to a compatibilized polyester resin such as PEN, PET, PBN, PBT or PTN with a polyamide resin such as for example, MXD6 resin, using carbodiimide (CDI) containing at least two carbodiimide groups in the molecule as a compatibilizing agent. It is demonstrated in the present invention that if PEN, PET, PBN, PBT or PTN resin and polyamide (PA) resin can be compatibilized during extrusion using CDI with at least two carbodiimide groups in the molecule as a compatibilizing agent, a unique high modulus, abrasion resistant monofilament is created. One aspect of the invention also relates to polyester-polyamide compatibilization to create a dimensionally stable, abrasion resistant monofilament using CDI.

For a better understanding of the invention, its operating advantages and specific objects attained by its uses, reference is made to the accompanying descriptive matter in which preferred, but non-limiting, embodiments of the invention are illustrated.

Terms “comprising” and “comprises” in this disclosure can mean “including” and “includes” or can have the meaning commonly given to the term “comprising” or “comprises” in US Patent Law. Terms “consisting essentially of” or “consists essentially of” if used in the claims have the meaning ascribed to them in US Patent Law. Other aspects of the invention are described in or are obvious from (and within the ambit of the invention) the following disclosure.

### BRIEF DESCRIPTION OF THE DRAWINGS

The accompanying drawings, which are included to provide a further understanding of the invention, are incorporated in and constitute a part of this specification. The drawings presented herein together with the description serve to explain the principles of the invention. In the drawings:

FIGS. 1(a)-1(b) depict the morphology of polyester-polyamide blends;

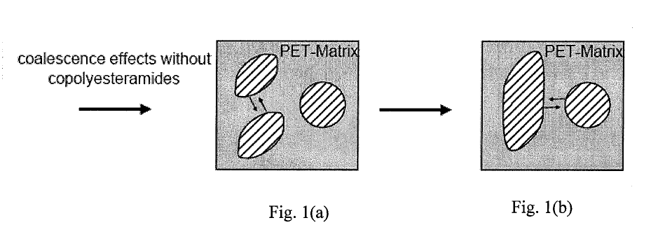

FIG. 2 shows a cross-sectional view of a monofilament according to one aspect of the invention; and

FIG. 3 compares abrasion resistance of a pure PEN monofilament with that of a monofilament according to one embodiment of the invention.

### DETAILED DESCRIPTION OF THE INVENTION

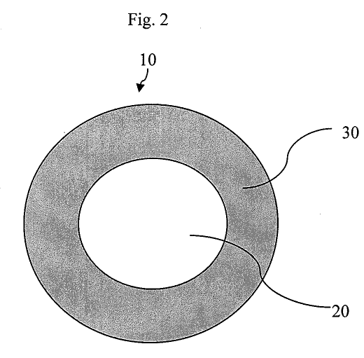

The invention, according to one embodiment, is a monofilament yarn or fiber, filament, film or tape composed of a blend of a polyester selected from a group including but not limited to, e.g. polyethylene naphthalate (PEN), polyethylene terephthalate (PET), polybutylene naphthalate (PBN), polytrimethylene naphthalate (PTN), polybutylene terephthalate (PBT), aromatic, copolymers and blends of polyester, and a polyamide (PA) selected from a group including but not limited to, e.g. PA 6; PA 6,6; PA 6,12; PA 6,10; PA 4,6; PA10; PA1 2; MXD6, aromatic, copolymers and blends of polyamide resins. The compatibilizer used for combining polyester with polyamide is a carbodiimide (CDI) containing at least two carbodiimide groups in the molecule. The monofilament can be in pure form containing the blended polymer throughout the entire yarn cross-section or can be a bicomponent yarn 10 formed in a sheath/core form, for example, wherein either the sheath 30 is the blended material and the core 20 is 100% pure PET, PEN, PBT, PTN, PBN, PA 6; PA 6,6; PA 6,12; PA 6,10; PA 4,6; PA10; PA12 or MXD6, as shown in FIG. 2, or vice versa.

The monofilament disclosed herein may be used as warp and/or weft yarns in the production of industrial fabrics such as paper machine clothing and engineered fabrics. The filament may also be used in fiber batt material that may be attached to the base structure of these fabrics. The compatibilized mixture of polyester and polyamide provides the monofilament with high modulus, improved fibrillation resistance and abrasion resistance. The above disclosed composition can also be used to produce a polymeric film or tape according to one embodiment of the invention.

The invention according to one embodiment is a method of manufacture of the above described monofilament, yarn or fiber. In this method, a compatibilizer e.g. carbodiimide (CDI), is used for combining a polyester resin with a polyamide resin to form a polymeric resin with a desired mixture of both components, such that favorable properties of both polymers are retained in the mixture. The compatibilizer, CDI, reacts with polyester and polyamide (PA) as follows:

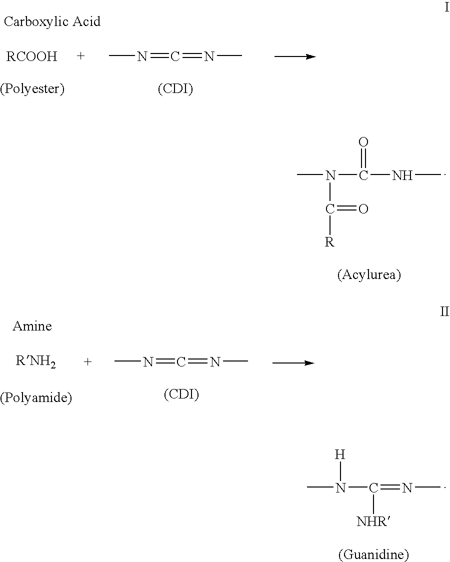

where R and R′ are alkyl groups with one or more carbon atoms.

As shown in Equations I and II, polyester results in Acylurea when it reacts with CDI, and polyamide reacts with CDI to form Guanidine, respectively. The reactions disclosed herein may not only occur through end group chemistry but also through both transesterfication and/or transamidation of the component elements, particularly in the melt state. The present invention is not limited to the chemical reactions disclosed herein but also includes other modifications to these reactions, which fall within the scope of the invention.

An illustrative example of the chemical reaction involved in mixing the two polymers, according to one aspect of the invention, is shown in Equations III and IV below. Particularly, when polyamide MXD6 is mixed with a compatibilizer e.g. carbodiimide (CDI) containing at least two carbodiimide groups in the molecule, and then mixed with polyethylene naphthalate (PEN), the following coupling reactions occur (Equations III and IV), resulting in the coupling of the PEN and polyamide MXD6 via polymeric CDI. The mixture, according to another embodiment can be formed by mixing PEN with a carbodiimide first and then combining this mixture with polyamide:

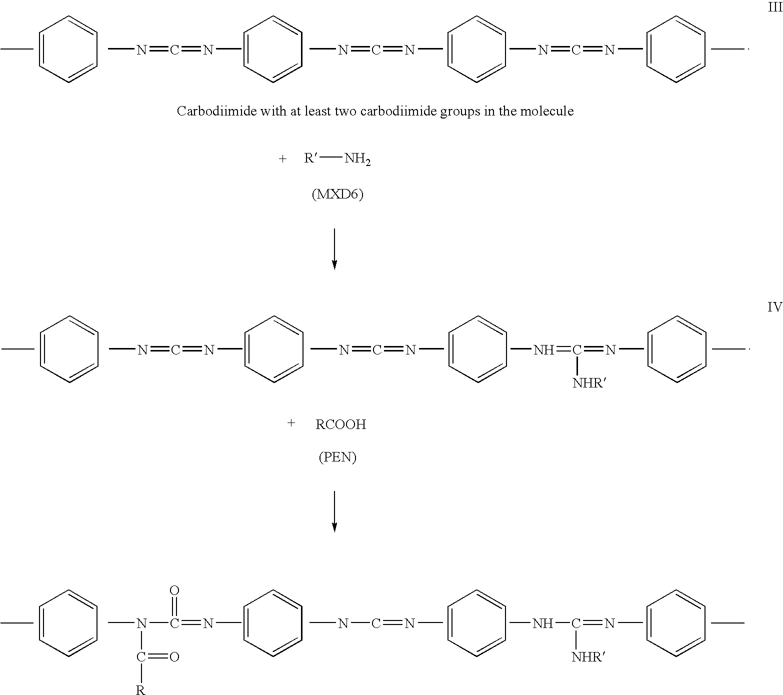

where R and R′ are alkyl groups with one or more carbon atoms.

As examples, the following resin blends were compounded and pelletized with a polyester and polyamide resin via polymeric CDI (0.01 to 3% by weight) on a twin screw extruder in three different percentage by weight proportions respectively. The resin blend examples particularly include, as a percentage by weight:
1. 100% PEN
2. 96.5% PEN, 3% MXD6 and 0.5% CDI;
3. 96.9% PEN, 3% MXD6 and 0.1% CDI;
4. 96.7% PEN, 3% MXD6 and 0.3% CDI;
5. 96% PEN, 3.5% MXD6 and 0.5% CDI;
6. 85% PEN and 15% MXD6; and
7. 75% PEN and 25% MXD6 respectively.

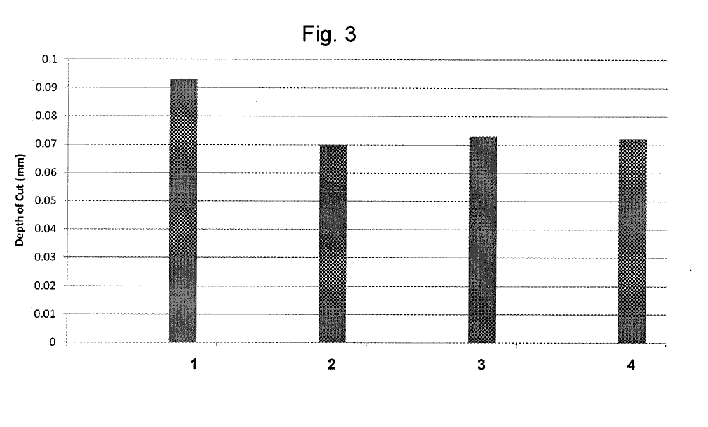

These resin blends were separately dried in desiccant drying hoppers. Each resin was separately blended with CDI and compounded into pellets using a twin screw extruder. The compounded pellets were then dried again before extrusion into 0.20 mm monofilaments. Blends of PEN/CDI pellets, MXD6/CDI pellets and CDI were extruded into 0.20 mm monofilaments. The tensile modulus, stress/strain and 200° C. shrink properties of Examples 1, 2, 3 and 4 are listed in Table I below. Based upon an inhouse abrasion test found suitable to predict field performance, samples from these examples were also tested for their abrasion resistance, and the test results showed at least a 20% improvement in abrasion resistance when compared to 100% pure PEN monofilaments used in papermachine clothing. A graph comparing the abrasion resistance test results is shown in FIG. 3.

TABLE I

| | Tenacity | Strain @ | Break | Modulus | 200 C. | CDI Level |
|---|---|---|---|---|---|---|
| Example | (GPD) | 3 gpd(%) | Strain (%) | (gpd) | Shrink (%) | (%) |
| 1 | 6.2 | 2.47 | 14.7 | 182 | 8 | 0 |
| 2 | 5.7 | 1.89 | 11 | 203 | 7.2 | 0.5 |
| 3 | 5.7 | 1.89 | 11.5 | 203 | 6.5 | 0.1 |
| 4 | 5.5 | 1.85 | 10 | 204 | 6.6 | 0.3 |

Other examples of blends, which fall within the scope of the invention include:

A blend of PET and MXD6 resin including approximately:
8. 95% PET and 5% MXD6;
9. 90% PET and 10% MXD6;
10. 85% PET and 15% MXD6;
11. 75% PET and 25% MXD6;

A blend of PBT and MXD6 resin including approximately:
12. 95% PBT and 5% MXD6;
13. 90% PBT and 10% MXD6;
14. 85% PBT and 15% MXD6; and
15. 75% PBT and 25% MXD6 respectively.

Included in these examples are appropriate amounts of CDI, ranging from 0.01-3% by weight, along with the other components adjusted accordingly.

It is to be noted that these compositions are purely exemplary and that the scope of the present invention is not limited to or confined to the above disclosed examples.

Thus by the present invention, monofilaments were made from compatibilized polyester and polyamide blended resins, with improved fibrillation resistance/abrasion resistance, and mechanical properties in general compared to yarns of pure 100% resin. The monofilament can be in pure form containing the blended polymer throughout the entire yarn cross-section or can be formed in a sheath-core form, wherein either the sheath is the blended material and the core is 100% pure PET, PBT, PEN, PTN, PBN, PA 6, PA 6,6, PA 6,12, PA 6,10, PA 4,6, PA10, PA12 or MXD6, or vice versa as disclosed earlier.

Accordingly, in one of its embodiments, the present invention provides the following polyester-polyamide resin compositions:

(I) A polyester-polyamide resin composition 100 parts by weight of a mixture comprising 50 to 98.99% by weight of a polyester resin produced by polymerization of a carboxylic acid component, such as PEN, and 1 to 49.99% by weight of a polyamide resin produced by polymerization of an amine component, such as MXD6, and 0.01 to 3% by weight of a compatibilizer, such as carbodiimide, containing at least two carbodiimide groups in the molecule. Preferably, a mixture comprising 75 to 98.99% by weight of a polyester resin produced by polymerization of a carboxylic acid component, such as PEN, and 24.99 to 1% by weight of a polyamide resin produced by polymerization of a amine component, such as MXD6 and 0.01 to 3% by weight of a compatibilizer, such as carbodiimide;

(II) A polyester-polyamide resin composition 100 parts by weight of a mixture comprising 50 to 98.99% by weight of a polyester resin produced by polymerization of a carboxylic acid component, such as PET, and 1 to 49.99% by weight of a polyamide resin produced by polymerization of an amine component, such as MXD6, and 0.01 to 3% by weight of a compatibilizer, such as carbodiimide, containing at least two carbodiimide groups in the molecule. Preferably, a mixture comprising 75 to 98.99% by weight of a polyester resin produced by polymerization of a carboxylic acid component, such as PET and 24.99 to 1% by weight of a polyamide resin produced by polymerization of a amine component, such as MXD6 and 0.01 to 3% by weight of a compatibilizer, such as carbodiimide; and

(III) A polyester-polyamide resin composition 100 parts by weight of a mixture comprising 50 to 98.99% by weight of a polyester resin produced by polymerization of a carboxylic acid component, such as PBT, and 1 to 49.99% by weight of a polyamide resin produced by polymerization of an amine component, such as MXD6, and 0.01 to 3% by weight of a compatibilizer, such as carbodiimide, containing at least two carbodiimide groups in the molecule. Preferably, a mixture comprising 75 to 98.99% by weight of a polyester resin produced by polymerization of a carboxylic acid component, such as PBT and 24.99 to 1% by weight of a polyamide resin produced by polymerization of a amine component, such as MXD6 and 0.01 to 3% by weight of a compatibilizer, such as carbodiimide.

The polyester-polyamide resin composition according to the present invention is suitable for the production of fibers, filaments, yarns, films and tapes. More specifically, the polyester-polyamide resin composition is suitable for manufacturing mono/multifilament yarns, fibers, films and tapes that can be used in the manufacture of forming, pressing, and dryer fabrics, as well as process belts used in papermaking, impression fabrics; TAD fabrics; engineered fabrics used in the production of nonwoven by processes such as melt-blowing; fabrics used in a sludge filter or other wet filtration process; base support structures for industrial process belts, such as conveyor belts for industrial uses such as food processing or mining; corrugator belts; spiral links for spiral link belts, their pintles or any stuffer yarns; or fabrics used in textile finishing processes, and a method of manufacturing the same. Any of the above structures with yarns can be woven or not woven, including spiral link structures as well as MD/CD yarn arrays.

The invention, according to another embodiment, is an industrial fabric, examples of which were noted earlier herein, composed of compatibilized PEN/PET/PBN/PBT/PTN and polyamide resin using CDI containing at least two carbodiimide groups in the molecule as a compatibilizing agent. PEN/PET/PBN/PBT/PTN resin and polyamide resin are compatibilized, as shown above, during extrusion using polymeric CDI with at least two carbodiimide groups in the molecule as a compatibilizing agent, thus creating a unique high modulus, abrasion resistant monofilament for use in the fabric.

Thus by the present invention, its objects and advantages are realized, and although preferred embodiments have been disclosed and described in detail herein, its scope and objects should not be limited thereby; rather its scope should be determined by that of the appended claims.

1. A polymeric resin composition comprising:
a polyester resin produced by polymerization of a carboxylic acid component;
a polyamide resin produced by polymerization of an amine component; and
a carbodiimide component containing at least two carbodiimide groups in the molecule.

2. The polymeric resin composition according to claim 1, wherein 100 parts by weight of the polymeric resin composition comprises 50 to 98.99% by weight of a polyester resin produced by polymerization of a carboxylic acid component; 49.99 to 1% by weight of a polyamide resin produced by polymerization of a amine component; and 0.01 to 3% by weight of a carbodiimide component containing at least two carbodiimide groups in the molecule.

3. The polymeric resin composition according to claim 2, wherein 100 parts by weight of the polymeric resin composition comprises preferably 75 to 98.99% by weight of a polyester resin produced by polymerization of a carboxylic acid component; 24.99 to 1% by weight of a polyamide resin produced by polymerization of a amine component; and 0.01 to 3% by weight of a carbodiimide component containing at least two carbodiimide groups in the molecule.

4. The polymeric resin composition according to claim 1, wherein said polyamide resin is PA 6; PA 6,6; PA 6,12; PA 6,10; PA 4,6; PA10; PA12 or MXD6; aromatic, copolymers or blends of polyamide.

5. The polymeric resin composition according to claim 1, wherein said polyester resin is selected from the group consisting of polyethylene terephthalate, polybutylene terephthalate, polybutylene naphthalate, polytrimethylene naphthalate, polyethylene naphthalate, aromatic, copolymers and blends of polyester resin.

6. A monofilament, fiber, film, yarn or tape produced from a polymeric resin composition comprising:
a polyester resin produced by polymerization of a carboxylic acid component;
a polyamide resin produced by polymerization of an amine component; and
a carbodiimide containing at least two carbodiimide groups in the molecule.

7. The monofilament according to claim 6, wherein 100 parts by weight of the polymeric resin composition comprises 50 to 98.99% by weight of a polyester resin produced by polymerization of a carboxylic acid component; 49.99 to 1% by weight of a polyamide resin produced by polymerization of a amine component; and 0.01 to 3% by weight of a carbodiimide component containing at least two carbodiimide groups in the molecule.

8. The monofilament according to claim 7, wherein 100 parts by weight of the polymeric resin composition comprises preferably 75 to 98.99% by weight of a polyester resin produced by polymerization of a carboxylic acid component; 24.99 to 1% by weight of a polyamide resin produced by polymerization of a amine component; and 0.01 to 3% by weight of a carbodiimide component containing at least two carbodiimide groups in the molecule.

9. The monofilament according to claim 6, wherein said polyamide resin is PA 6; PA 6,6; PA 6,12; PA 6,10; PA 4,6; PA10; PA12 or MXD6; aromatic, copolymers or blends of polyamide.

10. The monofilament according to claim 6, wherein said polyester resin is selected from the group consisting of polyethylene terephthalate, polybutylene terephthalate, polybutylene naphthalate, polytrimethylene naphthalate, polyethylene naphthalate, aromatic, copolymers and blends of polyester resin.

11. The monofilament according to claim 6, wherein said monofilament is formed in a sheath-core form,
wherein either the sheath comprises the polymeric resin composition and the core is 100% polyester or polyamide, or vice versa.

12. An industrial fabric comprising one or more monofilaments, fibers, films, yarns or tapes produced from a polymeric resin composition comprising:
a polyester resin produced by polymerization of a carboxylic acid component;
a polyamide resin produced by polymerization of an amine component; and
a carbodiimide containing at least two carbodiimide groups in the molecule.

13. The fabric according to claim 12, wherein 100 parts by weight of the polymeric resin composition comprises 50 to 98.99% by weight of a polyester resin produced by polymerization of a carboxylic acid component; 49.99 to 1% by weight of a polyamide resin produced by polymerization of a amine component; and 0.01 to 3% by weight of a carbodiimide component containing at least two carbodiimide groups in the molecule.

14. The fabric according to claim 13, wherein 100 parts by weight of the polymeric resin composition comprises preferably 75 to 98.99% by weight of a polyester resin produced by polymerization of a carboxylic acid component; 24.99 to 1% by weight of a polyamide resin produced by polymerization of a amine component; and 0.01 to 3% by weight of a carbodiimide component containing at least two carbodiimide groups in the molecule.

15. The fabric according to claim 12, wherein said polyamide resin is PA 6; PA 6,6; PA 6,12; PA 6,10; PA 4,6; PA10; PA12 or MXD6; aromatic, copolymers or blends of polyamide.

16. The fabric according to claim 12, wherein said polyester resin is selected from the group consisting of polyethylene terephthalate, polybutylene terephthalate, polybutylene naphthalate, polytrimethylene naphthalate, polyethylene naphthalate, aromatic, copolymers and blends of polyester resin.

17. The fabric according to claim 12, wherein said monofilament has a sheath-core structure,
wherein either the sheath comprises the polymeric composition and the core is 100% polyester or polyamide, or vice versa.
